(19) United States
(12) Patent Application Publication
(10) Pub. No.: US 2020/0386261 A1
(43) Pub. Date: Dec. 10, 2020

(54) FASTENER

(71) Applicant: ILLINOIS TOOL WORKS INC., Glenview, IL (US)

(72) Inventors: Xing WANG, Shanghai (CN); Mengli SUN, Shanghai (CN)

(21) Appl. No.: 16/895,036

(22) Filed: Jun. 8, 2020

(30) Foreign Application Priority Data
Jun. 6, 2019 (CN) 201910490423.9

(51) Int. Cl. F16B 37/04

(52) U.S. Cl. CPC F16B 37/042

(57) ABSTRACT

Disclosed is a fastener, comprising: a fastener main body having a side wall; a pair of blocking bosses, a pair of blocking boss gaps being formed between the pair of blocking bosses; a pair of clamping steps; and a pair of resilient holding arms, each resilient holding arm having a connecting end and a free end, wherein the connecting end is connected to the side wall of the fastener main body; wherein a panel gap is formed between the blocking boss and the clamping step in an axial direction of the fastener main body; and wherein the connecting end of the resilient holding arm is arranged in the corresponding blocking boss gap between the blocking bosses and is staggered from the clamping steps.

### TECHNICAL FIELD

The present application relates to a fastener, and in particular to a fastener for mounting a vehicle radar.

### BACKGROUND ART

In the prior art, various external devices need to be mounted on a vehicle. Mounting panels are generally used to mount the external devices at preset positions on the vehicle. For example, by providing a mounting panel, an external device, e.g., a radar system, can be mounted on a bumper in the front of the vehicle. At this time, it is necessary to ensure the firmness of connection between the external device and the mounting panel. Generally, fasteners can be provided to firmly connect the external device to the mounting panel.

### SUMMARY OF THE INVENTION

In order to solve the above problems, at least one object of the present application is to provide a fastener that can ensure a firm connection between an external device and a mounting panel.

In a first aspect, the present application provides a fastener comprising: a fastener main body having a side wall; a pair of blocking bosses, which are arranged on opposite sides, in a circumferential direction, of the side wall of the fastener main body and are formed by protruding outward from an outer surface of the side wall of the fastener main body, a pair of blocking boss gaps being formed between the pair of blocking bosses; a pair of clamping steps, which are arranged on opposite sides, in the circumferential direction, of the side wall of the fastener main body and formed by protruding outward from the outer surface of the side wall of the fastener main body; and a pair of resilient holding arms, each resilient holding arm having a connecting end and a free end, wherein the connecting end is connected to the side wall of the fastener main body; wherein a panel gap is formed between the pair of blocking bosses and the pair of clamping steps in an axial direction of the fastener main body; and wherein the connecting end of each of the pair of resilient holding arms is arranged in the corresponding blocking boss gap between the pair of blocking bosses and is staggered from the pair of clamping steps.

According to the first aspect, a pair of clamping step gaps are formed between the pair of clamping steps; each of the pair of resilient holding arms is arranged in the corresponding clamping step gap between the pair of clamping steps and is staggered from the pair of clamping steps in the circumferential direction of the fastener main body.

According to the first aspect, the free end of each of the pair of resilient holding arms is arranged in the panel gap between the pair of blocking bosses and the pair of clamping steps.

According to the first aspect, each of the pair of resilient holding arms comprises a bent portion, the connecting end extends outward to be connected to the bent portion, and the bent portion extends downward to be connected to the free end.

According to the first aspect, the pair of clamping steps are correspondingly arranged below the pair of blocking bosses.

According to the first aspect, the fastener is used for being mounted in a mounting hole of a mounting panel, and the mounting hole has opposite ends; wherein each of the pair of clamping steps has an outer contour matching with the ends of the mounting hole in shape; the ends accommodate the pair of clamping steps when the fastener is in a mounting position relative to the mounting hole; and the ends accommodate the free ends of the pair of resilient holding arms when the fastener is rotated to a fastening position relative to the mounting hole.

According to the first aspect, the panel gap between the pair of blocking bosses and the pair of clamping steps is used for accommodating the mounting panel.

According to the first aspect, the fastener further comprises: a plurality of resilient ribs, which are connected to an inner surface of the side wall of the fastener main body, the top of each of the plurality of the resilient ribs forming a support portion inclining inward from top to bottom, and the bottom of each of the plurality of resilient ribs forming a guide portion inclining inward from bottom to top; and a plurality of limiting ribs, which are formed by protruding inward from the inner surface of the side wall of the fastener main body, the top of each of the plurality of the limiting ribs having a blocking portion, and a recess portion inclining outward from top to bottom being formed below the blocking portion; wherein a cavity is formed between the support portion and the blocking portion.

According to the first aspect, the plurality of resilient ribs and the plurality of limiting ribs are alternately arranged.

According to the first aspect, at least one of two opposite sides of the free end of each of the pair of resilient holding arms is provided with a bevel.

### BRIEF DESCRIPTION OF THE DRAWINGS

FIG. 1A is a structural perspective schematic diagram of a fastener 100 of the present application;

FIG. 1B is a structural perspective schematic diagram of the fastener 100 in FIG. 1A from another perspective on a right side thereof;

FIG. 2 is a front view of the fastener 100 in FIG. 1A;

FIG. 3 is a front view of the fastener 100 in FIG. 1B;

FIG. 4A is a top view of the fastener 100 in FIG. 1A;

FIG. 4B is a cross-sectional view of the fastener 100 in FIG. 4A along line A-A;

FIGS. 5A and 5B are structural schematic diagrams when the fastener 100 is aligned with a mounting hole 560 on a mounting panel 510;

FIGS. 6A and 6B are structural schematic diagrams when the fastener 100 is just inserted into the mounting hole 560 and the mounting hole 560 accommodates clamping steps;

FIGS. 7A and 7B are structural schematic diagrams when the fastener 100 is inserted into the mounting hole 560 and the clamping steps pass through the mounting hole 560;

FIG. 8A-8C are structural schematic diagrams when the fastener 100 is rotated and the mounting hole 560 accommodates resilient holding arms; and

FIG. 9A-9C are structural schematic diagrams in the process of assembling a dome post into the fastener 100.

### DETAILED DESCRIPTION OF EMBODIMENTS

Various specific embodiments of the present application are described below with reference to the accompanying drawings which constitute part of this description. It should be understood that although the terms, such as “front”, “rear”, “upper”, “lower”, “left”, “right”, “head”, “tail”, “obverse”, “reverse”, “top”, “bottom”, and so on, indicating directions in the present application are used to describe various exemplary structural parts and elements in the present application, these terms used herein are merely used for ease of description and are determined based on the exemplary orientation shown in the accompanying drawings. Since the embodiments disclosed in the present application can be arranged in different directions, these terms indicating directions are only illustrative and should not be considered as limitations.

In order to facilitate description of specific embodiments, in the present application, a height direction of a fastener 100 is taken as an axial direction of the fastener 100 (i.e., an axial direction of a fastener main body 104) to illustrate exemplarily; and a circumferential direction of the fastener 100 (i.e., a circumferential direction of the fastener main body 104) refers to a direction around the axial direction of the fastener, and a radial direction of the fastener 100 (i.e., a radial direction of the fastener main body 104) is relatively perpendicular to the axial direction thereof.

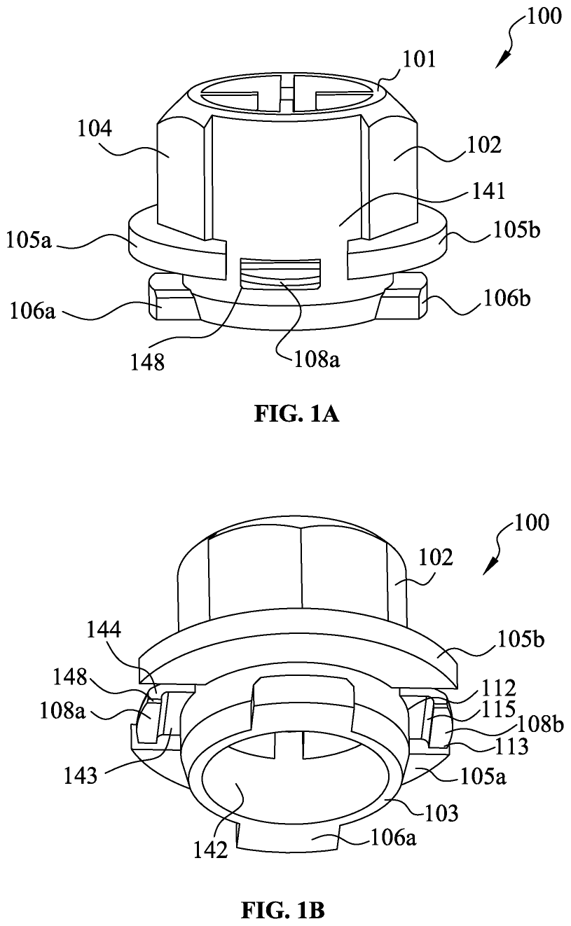

FIG. 1A is a structural perspective schematic diagram of the fastener 100 of the present application when viewed from above. FIG. 1B is a structural perspective schematic diagram of the fastener 100 of the present application when viewed from right and bottom, and is used to illustrate an overall structure of the fastener 100 and specific structures of resilient holding arms from different perspectives.

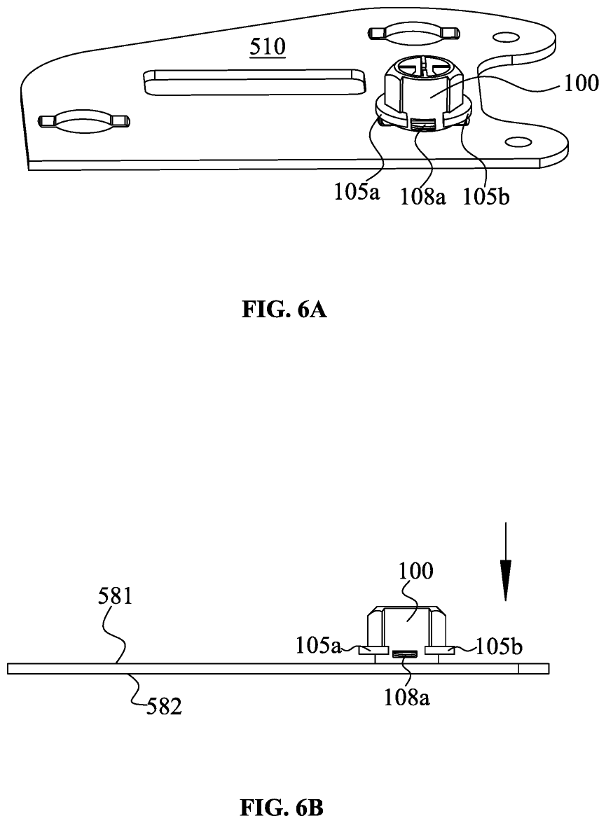

As shown in FIGS. 1A and 1B, the fastener 100 comprises the fastener main body 104, a pair of blocking bosses 105a and 105b, a pair of clamping steps 106a and 106b, and a pair of resilient holding arms 108a and 108b. As shown in FIG. 1A, the fastener main body 104 has a hollow sleeve shape, the pair of blocking bosses 105a and 105b are arranged on both left and right sides of the fastener main body 104 (i.e., both front and rear sides in FIG. 1B), and the pair of clamping steps 106a and 106b are also arranged on both left and right sides of the fastener main body 104 and are located below the pair of blocking bosses 105a and 105b. The pair of resilient holding arms 108a and 108b are arranged on both front and rear sides of the fastener main body 104 (i.e., both left and right sides in FIG. 1B). When the fastener 100 is mounted on a mounting panel 510 (see FIGS. 5A-8C), the pair of blocking bosses 105a and 105b and the pair of clamping steps 106a and 106b can restrict the fastener 100 from axial movement, and the resilient holding arms 108a and 108b serve to restrict the fastener 100 from rotating.

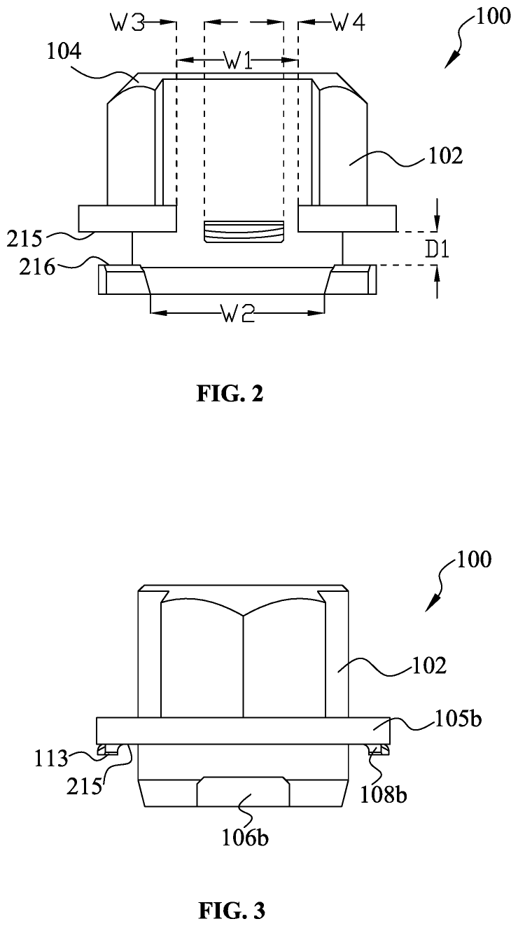

Specifically, the blocking boss 105a is formed by protruding outward radially from an outer surface 141 of a side wall 102 on a left side of the fastener main body 104, and the blocking boss 105b is formed by protruding outward radially from the outer surface 141 of the side wall 102 on a right side of the fastener main body 104. A blocking boss gap W1 is respectively formed between the blocking bosses 105a and 105b in front and rear directions (see FIG. 2). As an example, the blocking bosses 105a and 105b are arranged substantially symmetrically.

The clamping steps 106a and 106b are also symmetrically arranged, and are respectively formed by protruding outward radially from the outer surface 141 of the side wall 102 on both left and right sides of the fastener main body 104; and the clamping step 106a is arranged below the blocking boss 105a, and the clamping step 106b is arranged below the blocking boss 105b. A clamping step gap W2 is respectively formed between the clamping steps 106a and 106b in the front and rear directions (see FIG. 2). It should be noted that, in other embodiments, the clamping steps 106a and 106b may also be arranged above the blocking bosses 105a and 105b, respectively.

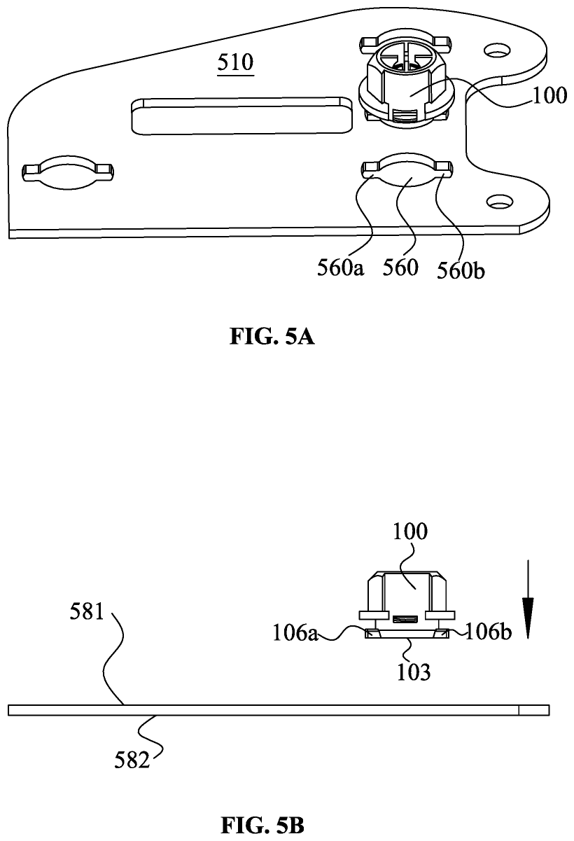

In a cavity inside the fastener main body 104, a plurality of resilient ribs and a plurality of limiting ribs are also arranged, which are connected to an inner surface 142 of the side wall 102, which will be described later in conjunction with FIG. 4B.

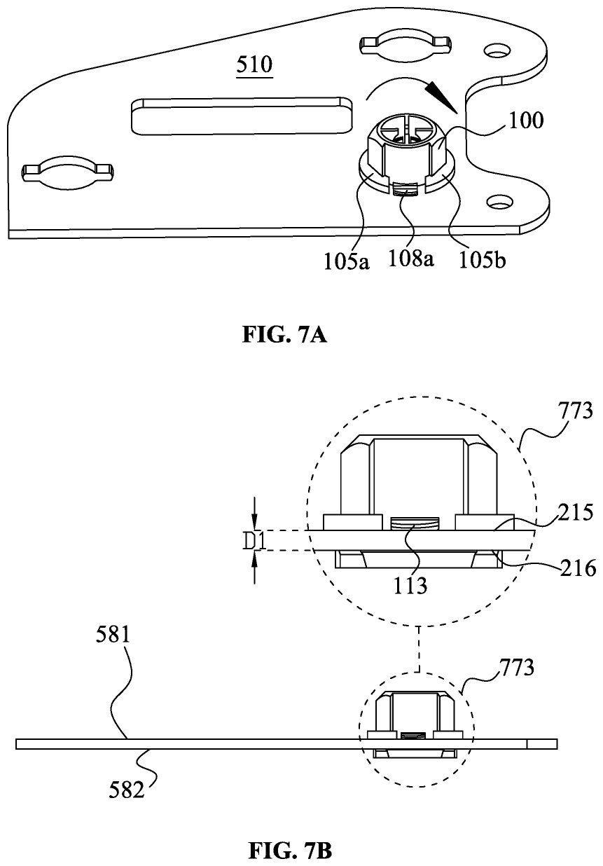

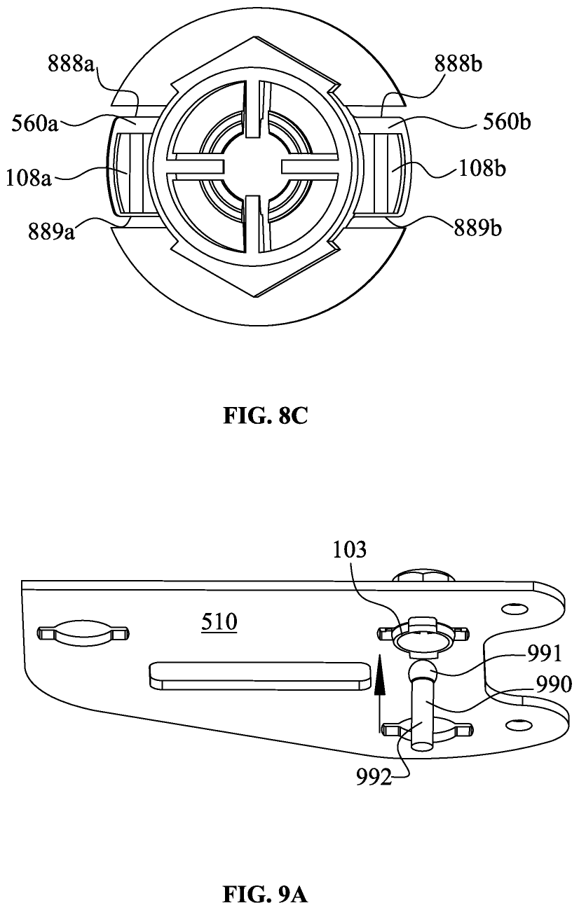

As shown in FIG. 1B, the resilient holding arms 108a and 108b are also symmetrically arranged and connected within the blocking boss gaps W1 and aligned with the clamping step gaps W2 (the resilient holding arms 108a and 108b being aligned with the clamping step gaps W2 means that, in the circumferential direction of the fastener main body 104, the resilient holding arms 108a and 108b are arranged within the clamping step gaps W2). As an example, the resilient holding arms 108a and 108b each comprises a connecting end 112, a bent portion 115, and a free end 113, wherein the connecting end 112 is connected to the outer surface 141 of the side wall 102 of the fastener main body 104 and is arranged within the blocking boss gap W1. In the circumferential direction of the fastener main body 104, the connecting end 112 is also arranged within the clamping step gap W2, so that the resilient holding arms 108a and 108b are staggered from the clamping steps 106a and 106b, for example, a centerline of the resilient holding arms 108a and 108b is staggered by 90° from a centerline of the clamping steps 106a and 106b. That is to say, in the circumferential direction of the fastener main body 104, the clamping step 106a, the resilient holding arm 108a, the clamping step 106b, and the resilient holding arm 108b are successively arranged at intervals of 90°. This arrangement enables ends 560a and 560b of a mounting hole 560 on the mounting panel 510 to be aligned with the clamping steps 106a and 106b when the fastener 100 is at an angle relative to the mounting panel 510 (see FIGS. 6A-6B); and to be aligned with the resilient holding arms 108a and 108b when the fastener 100 is at another angle relative to the mounting panel 510 (for example, rotated by about 90°) (see FIGS. 8A-8C).

More specifically, the connecting end 112 extends outward radially to form a lateral arm 143, and the lateral arm 143 is connected to a side of the bent portion 115 that is bent downward. The other side of the bent portion 115 extends downward again to form a longitudinal arm 144, and the longitudinal arm 144 is connected to the free end 113. As an example, at least one of two opposite sides of the free end 113 is also provided with a bevel 148 that is retracted inward and inclines from top to bottom, and the bevel 148 is used for being in contact with limiting side walls (see 888a, 888b and 889a, 889b in FIG. 8C) at both sides of the ends of the mounting hole 560 on the mounting panel 510.

When the free ends 113 of the resilient holding arms 108a and 108b are subjected to an upward squeeze force, the resilient holding arms 108a and 108b can be lifted upward; and when the squeeze force on the free ends 113 of the resilient holding arms 108a and 108b is removed, the resilient holding arms 108a and 108b fall and return to an initial state shown in FIG. 1B.

When the resilient holding arms 108a and 108b of the fastener 100 fall into the mounting hole 560 on the mounting panel 510, and the fastener 100 is subjected to a greater rotational force again, the rotational force can produce an upward force component on the bevel 148, so that the resilient holding arms 108a and 108b are lifted upward away from the mounting hole 560.

FIG. 2 is a front view of the fastener 100 in FIG. 1A, more specifically showing positional relationships among the pair of blocking bosses 105a and 105b, the pair of clamping steps 106a and 106b, and the pair of resilient holding arms 108a and 108b.

As shown in FIG. 2, when viewed from the axial direction of the fastener main body 104, a panel gap D1 is formed between a lower surface 215 of each of the blocking bosses 105a and 105b and an upper surface 216 of each of the clamping steps 106a and 106b, and the size of the panel gap D1 matches the thickness of the mounting panel 510, so that when the fastener 100 is mounted on the mounting panel 510, the mounting panel 510 can be just accommodated between the blocking bosses 105a and 105b and the clamping steps 106a and 106b, and therefore, the fastener 100 can be prevented from moving up and down.

When viewed from the circumferential direction of the fastener main body 104, the size of the blocking bosses 105a and 105b protruding outward is larger than the size of the clamping steps 106a and 106b protruding outward, so that when the clamping steps 106a and 106b pass through the mounting hole 560 of the mounting panel 510, the blocking bosses 105a and 105b can abut against the mounting panel 510 without passing through the mounting hole 560 together with the clamping steps 106a and 106b. The connecting end 112 of the resilient holding arm 108a is arranged within the blocking boss gap W1, and is at least not lower than the lower surfaces 215 of the blocking bosses 105a and 105b. Moreover, the connection end 112 of the resilient holding arm 108a is separated from the blocking bosses 105a and 105b by W3 and W4, respectively, and as an example, W3 and W4 are different from each other in size. Although not shown in the figures, those skilled in the art should understand that the resilient holding arms 108b and 108a are arranged symmetrically, and the connecting end 112 of the resilient holding arm 108b is also separated from the blocking bosses 105a and 105b by W3 and W4, respectively.

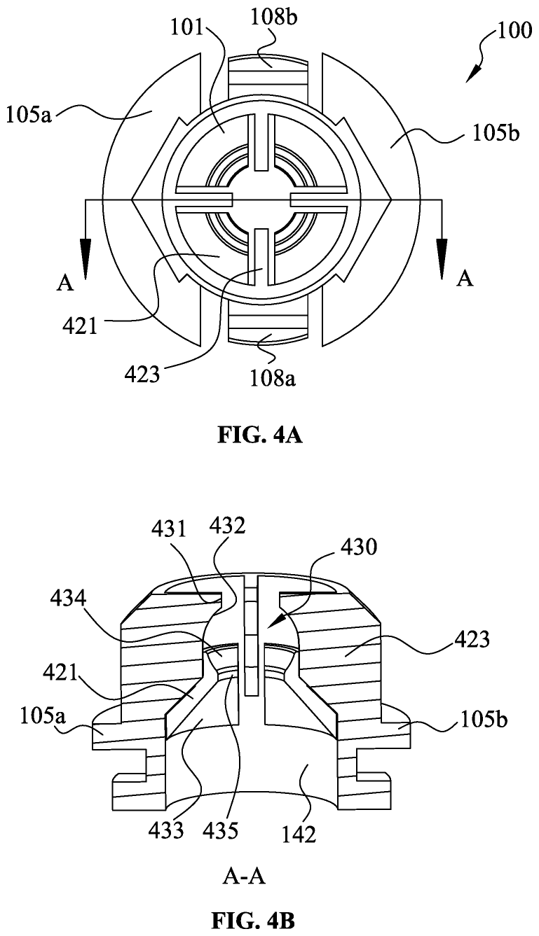

FIG. 3 is a front view of the fastener 100 in FIG. 1B, that is, a right view of FIG. 2, to more specifically show positional relationships in the axial direction of the fastener main body 104 among the pair of blocking bosses 105a and 105b, the pair of clamping steps 106a and 106b, and the pair of resilient holding arms 108a and 108b.

As shown in FIG. 3, the free ends 113 of the resilient holding arms 108a and 108b extend downward below the lower surfaces 215 of the blocking bosses 105a and 105b, but are still above the upper surfaces 216 of the clamping steps 106a and 106b, so that the free ends 113 of the resilient holding arms 108a and 108b are arranged within the panel gap D1. This arrangement enables the free ends 113 of the resilient holding arms 108a and 108b to extend into the mounting hole 560 of the mounting panel 510 when the free ends 113 are aligned with the mounting hole 560, so as to prevent the fastener 100 from rotating in the axial direction.

FIGS. 4A and 4B are used to show an internal structure of the fastener 100, wherein FIG. 4A is a top view of FIG. 1A, and FIG. 4B is a cross-sectional view of FIG. 4A along line A-A.

As shown in FIGS. 4A and 4B, the fastener 100 further comprises a plurality of resilient ribs 421 and a plurality of limiting ribs 423, which are arranged in the cavity inside the fastener main body 104 and connected to the inner surface 142 of the side wall 102 of the fastener main body 104. As an example, the plurality of resilient ribs 421 comprise four resilient ribs 421, and the plurality of limiting ribs 423 comprise four limiting ribs 423, and the four resilient ribs 421 and the four limiting ribs 423 are alternately arranged in the circumferential direction of the fastener main body 104. As an example, the resilient ribs 421 are connected to a middle portion of the inner surface 142 of the side wall 102 of the fastener main body 104 in the axial direction, and the limiting ribs 423 extend to a top 101 of the fastener main body 104 in the axial direction from the middle portion of the inner surface 142 of the side wall 102 of the fastener main body 104. As an example, the resilient rib 421 is made of a material with a certain elasticity, for example plastic. As an example, the resilient rib 421 and the limiting rib 423 are integrally formed with the fastener main body 104, and for example, are made of plastic, to facilitate processing.

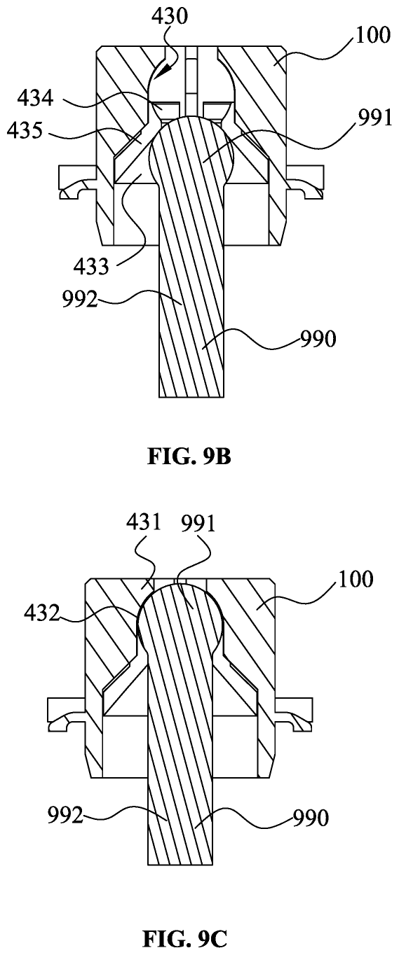

Specifically, the limiting rib 423 is formed by the inner surface 142 of the side wall 102 of the fastener main body 104 protruding inward, the top of the limiting rib 423 has a blocking portion 431, and the blocking portion 431 has a recess portion 432 formed by being obliquely recessed from top to bottom. As an example, the recess 432 of the limiting rib 423 is a smooth cambered surface for accommodating a spherical top surface 991 at the top of a dome post 990 (see FIGS. 9A-9C).

The resilient rib 421 comprises a support portion 434, a squeeze portion 435, and a guide portion 433 in sequence from top to bottom. Wherein the support portion 434 is formed by inclining inward between the top of the resilient rib 421 and the squeeze portion 435 from top to bottom, and the guide portion 433 is formed by inclining inward between the bottom of the resilient rib 421 and the squeeze portion 435 from bottom to top, such that the squeeze portion 435 is located at a largest distance from the inner surface 142 of the side wall 102 of the fastener main body 104. When the squeeze portion 435 is subjected to an upward squeeze force by the guide portion 433, the squeeze portion 435 can elastically deform upward in a cantilever-like manner, increasing the distance between each squeeze portion 435. The support portion 434 of the resilient rib 421 forms a cavity 430 together with the recess 432 of the limiting rib. As an example, the support portion 434 of the resilient rib 421 is also a smooth cambered surface, so that the cavity 430 is substantially spherical, and is sized to match the spherical top surface 991 at the top of the dome post 990. When the dome post 990 is inserted upward from a bottom 103 of the fastener main body 104 into the interior of the fastener main body 104, the spherical top surface 991 at the top of the dome post 990 first contacts the guide portion 433 of the resilient rib 421 and extends close to the squeeze portion 435, and then the spherical top surface 991 applies a squeeze force to the squeeze portion 435 by the guide portion 433, so that the squeeze portion 435 is elastically deformed upward, and the spherical top surface 991 at the top of the dome post 990 can continue to move upward across the squeeze portion 435 until the spherical top surface 991 is accommodated in the cavity 430 by the blocking portion 431 of the limiting rib 423. At this time, the support portion 434 of the resilient rib 421 and the recess 432 of the limiting rib fit with the spherical top surface 991, the squeeze portion 435 returns to the initial state, the support portion 434 of the resilient rib 421 prevents the dome post 990 from moving downward relative to the fastener 100, and the blocking portion 431 of the limiting rib 423 prevents the dome post 990 from moving upward relative to the fastener 100, so that the dome post 990 is easily mounted in the fastener 100 and is firmly mounted.

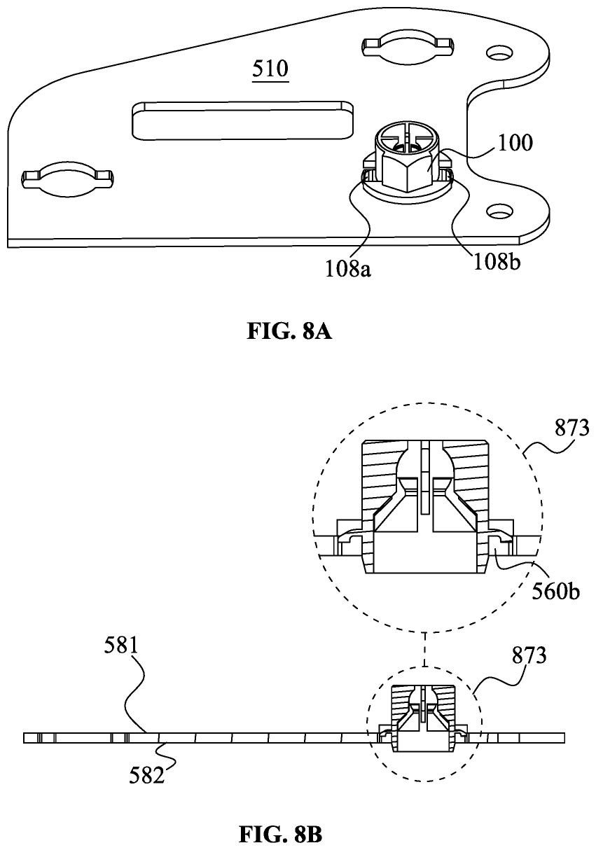

FIGS. 5A-8C show an assembly process of assembling the fastener 100 onto the mounting panel 510, wherein FIGS. 5A-5B show the state when the fastener 100 is aligned with the mounting hole 560 on the mounting panel 510, FIGS. 6A-6B show the state when the clamping steps 106a and 106b of the fastener 100 are inserted into the mounting hole 560 and the fastener 100 is in a mounting position, FIGS. 7A-7B show the state when the clamping steps 106a and 106b of the fastener 100 pass through the mounting hole 560 and the blocking bosses 105a and 105b abut against the mounting panel 510, and FIGS. 8A-8C show the state when the free ends 113 of the resilient holding arms 108a and 108b of the fastener 100 extend into the mounting hole 560 and the fastener 100 is in a fastening position.

Specifically, FIG. 5B is a front view of FIG. 5A. As shown in FIGS. 5A and 5B, the mounting panel 510 is provided with a plurality of mounting holes 560 extending from an upper surface 581 to a lower surface 582 of the mounting panel 510. As an example, the number of the mounting holes 560 may be three. The mounting hole 560 has the ends 560a and 560b at both ends, which extend outward from opposite ends of the mounting hole 560 and are shaped to match the clamping steps 106a and 106b of the fastener 100. After an operator aligns the clamping step 106a of the fastener 100 with the end 560a of the mounting hole 560 and aligns the clamping step 106b of the fastener 100 with the end 560b of the mounting hole 560, the fastener 100 can be inserted into the mounting hole 560 from top to bottom.

FIG. 6B is a front view of FIG. 6A. As shown in FIGS. 6A and 6B, the end 560a of the mounting hole 560 accommodates the clamping step 106a of the fastener 100, and the end 560b of the mounting hole 560 accommodates the clamping step 106b of the fastener 100. At this time, the fastener 100 is in the mounting position relative to the mounting hole 560. The operator continues to insert the fastener 100 downward into the mounting hole 560 to reach the state shown in FIGS. 7A and 7B.

FIG. 7B is a front view of FIG. 7A, and a dotted frame 773 shows a partial enlarged view. As shown in FIGS. 7A and 7B, the clamping steps 106a and 106b of the fastener 100 pass through the mounting hole 560 on the mounting panel 510. At this time, the lower surfaces 215 of the blocking bosses 105a and 105b abut against the upper surface 581 of the mounting panel 510, and the upper surfaces 216 of the clamping steps 106a and 106b abut against the lower surface 582 of the mounting panel 510, whereby the mounting panel 510 can be accommodated in the panel gap D1. Since the free ends 113 of the resilient holding arms 108a and 108b should be located below the lower surfaces 215 of the blocking bosses 105a and 105b in the initial state, the operator needs to apply downward pressure to the fastener 100 such that the free ends 113 of the resilient holding arms 108a and 108b are subjected to an upward squeeze force by the mounting panel 510. The resilient holding arms 108a and 108b can be lifted up until the free ends 113 are flush with the mounting panel 510 and abut against the upper surface 581 of the mounting panel 510.

When the operator rotates the fastener 100, such as rotating the fastener 100 counterclockwise, the fastener 100 can reach the fastening position shown in FIGS. 8A and 8B relative to the mounting hole 560.

FIG. 8B is a cross-sectional view taken along the axial cross-section of the fastener 100 in FIG. 8A, wherein a dotted frame 873 shows a partial enlarged view, and further, FIG. 8C is a partial top view of FIG. 8A. As shown in FIGS. 8A-8C, after the fastener 100 is rotated by 90°, the lower surfaces 215 of the blocking bosses 105a and 105b still abut against the upper surface 581 of the mounting panel 510, and the upper surfaces 216 of the clamping steps 106a and 106b also still abut against the lower surface 582 of the mounting panel 510. However, the free end 113 of the resilient holding arm 108a is aligned with the end 560a of the mounting hole 560, and the free end 113 of the resilient holding arm 108b is aligned with the end 560b of the mounting hole 560. Therefore, the free ends 113 of the resilient holding arms 108a and 108b are no longer subjected to the upward squeeze force of the mounting panel 510, and return to the initial state. Since the free ends 113 of the resilient holding arms 108a and 108b are located below the lower surfaces 215 of the blocking bosses 105a and 105b in the initial state, the free ends 113 can extend downward into the ends 560a and 560b of the mounting hole 560.

As shown in FIG. 8C, the end 560a of the mounting hole 560 has opposite limiting side walls 888a and 889a, and the end 560b has opposite limiting side walls 888b and 889b. When the fastener 100 is in the fastening position, the free end 113 of the resilient holding arm 108a is immediately adjacent to the limiting side wall 889a, so the fastener 100 cannot rotate counterclockwise. Accordingly, the free end 113 of the resilient holding arm 108b is immediately adjacent to the limiting side wall 889b, so the fastener 100 also cannot rotate clockwise. This can prevent the fastener 100 from rotating relative to the mounting panel 510 in the fastening position. In an embodiment of the present application, the sizes of the ends 560a and 560b of the mounting hole 560 may be larger than the sizes of the resilient holding arms 108a and 108b, so that the free ends 113 of the resilient holding arms extend into the ends 560a and 560b of the mounting hole 560, and the processing accuracy requirement of the mounting hole 560 is reduced. It can ensure that the fastener 100 cannot rotate relative to the mounting panel 510 by only ensuring that the resilient holding arms 108a and 108b are immediately adjacent to the limiting side walls 889a and 889b, respectively. Of course, the same effect can also be achieved if the resilient holding arms 108a and 108b are immediately adjacent to the limiting side walls 888a and 888b, respectively.

When the fastener 100 is in the fastening position as shown in FIGS. 8A-8C, the bevels 148 of the free ends 113 of the resilient holding arms 108a and 108b are in contact with the limiting side walls 889a and 889b, respectively. When the operator forcibly applies a large rotational force to the fastener 100, the force component of the rotational force on the bevels 148 of the resilient holding arms 108a and 108b enables the resilient holding arms 108a and 108b to disengage from the ends 560a and 560b of the mounting hole 560, whereby the fastener 100 can be removed from the mounting panel 510. By adjusting positions of the free ends 113 of the resilient holding arms 108a and 108b in the axial direction in the panel gap D1 or extension lengths of the free ends 113, the depth at which the free ends 113 extend into the mounting hole 560 can be adjusted, and thus the required rotational force can be adjusted.

FIGS. 9A-9C show the assembly process of assembling the dome post 990 into the fastener 100, wherein FIG. 9A is a structural perspective diagram when the dome post 990 is aligned with the bottom 103 of the fastener main body 104 of the fastener 100, FIG. 9B is a cross-sectional view in the process of inserting the dome post 990 into the fastener main body 104, and FIG. 9C is a cross-sectional view after completing the assembly of inserting the dome post 990 into the fastener main body 104.

As shown in FIG. 9A, the dome post 990 comprises a post 992 and the spherical top surface 991. The operator aligns the dome post 990 with the bottom 103 of the fastener main body 104 of the fastener 100, and then holds the post 992, and inserts the dome post 990 into the fastener main body 104 from bottom to top to reach the state shown in FIG. 9B.

As shown in FIG. 9B, during the insertion of the dome post 990 into the fastener main body 104, the spherical top surface 991 at the top of the dome post 990 first contacts the guide portion 433 of the resilient rib 421 and then extends to contact the squeeze portion 435. At this time, the operator needs to apply a certain upward acting force to the dome post 990, so that the spherical top surface 991 of the dome post 990 applies an upward squeeze force to the squeeze portion 435 by the guide portion 433, so that the squeeze portion 435 is deformed upward, and the spherical top surface 991 at the top of the dome post 990 can continue to move upward across the squeeze portion 435 to the state shown in FIG. 9C. In this embodiment, since the guide portion 433 is provided, the upward acting force applied by the operator to the dome post 990 can be converted into a squeeze force applied to the squeeze portion 435, thereby expanding and deforming the squeeze portion 435.

As shown in FIG. 9C, the spherical top surface 991 of the dome post 990 is accommodated in the cavity 430. At this time, the support portion 434 of the resilient rib 421 and the recess 432 of the limiting rib 423 fit with the spherical top surface 991, the support portion 434 of the resilient rib 421 prevents the dome post 990 from moving downward relative to the fastener 100, and the blocking portion 431 of the limiting rib 423 prevents the dome post 990 from moving upward relative to the fastener 100. Thereby, the dome post 990 can be fixed into the fastener 100. Since the fastener 100 has been assembled to the mounting panel 510 at this time, assembling the dome post 990 into the fastener 100 enables the dome post 990 and the mounting panel 510 to be mounted together.

Those skilled in the art should know that the dome post 990 can be connected to an external device, such as a vehicle radar, and so on, in a manner commonly used in the art, such as threaded connection or welding, and so on. Thus, the external device and the mounting panel can be connected together by the fastener 100.

In the present application, by providing the blocking bosses, clamping steps, and resilient holding arms on the outer surface of the side wall of the fastener main body of the fastener, firm mounting between the fastener and the mounting panel is ensured. At the same time, in the present application, by providing the resilient ribs and limiting ribs on the inner surface of the side wall of the fastener main body of the fastener, firm mounting between the fastener and the dome post is ensured. Thereby, it can be ensured that the dome post and the mounting panel are firmly connected together, thereby ensuring that the external device and the mounting panel can be firmly connected. In addition, in the present application, the fastener has a simple structure, and the requirements on the accuracy of the fastener and the mounting hole of the mounting panel are low, and the fastener can be integrally formed of a plastic material, which is easy to process and greatly saves on costs. In addition, the mounting manner in which the fastener is mounted on the mounting panel is simple to operate and easy to implement.

Although the present application is described with reference to the specific embodiments shown in the accompanying drawings, it should be understood that the fastener of the present application can have many variations without departing from the spirit and scope of the teaching of the present application. A person of ordinary skill in the art will also realize that there are different ways to alter the parameters in the embodiments disclosed in the present application, which fall within the spirit and scope of the present application and the claims.

1. A fastener, comprising:
a fastener main body having a side wall;
a pair of blocking bosses which are arranged on opposite sides, in a circumferential direction, of the side wall of the fastener main body and are formed by protruding outwards from an outer surface of the side wall of the fastener main body, a pair of blocking boss gaps being formed between the pair of blocking bosses;
a pair of clamping steps which are arranged on opposite sides, in the circumferential direction, of the side wall of the fastener main body and formed by protruding outwards from the outer surface of the side wall of the fastener main body;
a pair of resilient holding arms, each resilient holding arm having a connecting end and a free end, wherein the connecting end is connected to the side wall of the fastener main body;
wherein a panel space is formed between the pair of blocking bosses and the pair of clamping steps in an axial direction of the fastener main body; and
wherein the connecting end of each of the pair of resilient holding arms arranged in the corresponding blocking boss gap between the pair of blocking bosses and is staggered from the pair of clamping steps.

2. The fastener according to claim 1, characterized in that:
a pair of clamping step gaps are formed between the pair of clamping steps and
each of the pair of resilient holding arms is arranged in the corresponding clamping step gap between the pair of clamping steps and is staggered from the pair of clamping steps in the circumferential direction of the fastener main body.

3. The fastener according to claim 2, characterized in that:
the free end of each of the pair of resilient holding arms is arranged in the panel space between the pair of blocking bosses and the pair of clamping steps.

4. The fastener according to claim 3, characterized in that:
each of the pair of resilient holding arms comprises a bent portion, the connecting end extends outwards to be connected with the bent portion, and the bent portion extends downwards to be connected with the free end.

5. The fastener according to claim 1, characterized in that:
the pair of clamping steps are correspondingly arranged below the pair of blocking bosses.

6. The fastener according to claim 1, characterized in that:
the fastener is used for being mounted in a mounting hole of a mounting panel, the mounting hole has opposite ends;
wherein each of the pair of clamping steps has an outer contour matching with the ends of the mounting hole in shape;
the ends accommodate the pair of clamping steps when the fastener is in a mounting position relative to the mounting hole; and
the ends accommodate the free ends of the pair of resilient holding arms when the fastener is rotated to a fastening position relative to the mounting hole.

7. The fastener according to claim 6, characterized in that:
the panel space between the pair of blocking bosses and the pair of clamping steps is used for accommodating the mounting panel.

8. The fastener according to claim 1, characterized by further comprising:
a plurality of resilient ribs which are connected to an inner surface of the side wall of the fastener main body, a top of each resilient rib forming a support portion inclined inward from top to bottom, and a bottom of each resilient rib forming a guide portion inclined inward from bottom to top;
a plurality of limiting ribs which are formed by protruding inwards from the inner surface of the side wall of the fastener main body, wherein a top of each limiting rib is provided with a blocking portion, and wherein a recess portion inclined outwards from top to bottom is formed below the blocking portion; and
wherein a cavity is formed between the support portion and the blocking portion.

9. The fastener according to claim 8, characterized in that:
the plurality of resilient ribs and the plurality of limiting ribs are alternately arranged.

10. The fastener according to claim 1, characterized in that:
at least one of two opposite sides of the free end of each of the pair of resilient holding arms is provided with a bevel.
